(19) United States
(12) Patent Application Publication
(10) Pub. No.: US 2023/0364992 A1
(43) Pub. Date: Nov. 16, 2023

(54) SYSTEM FOR RECOGNIZING GESTURE FOR VEHICLE AND METHOD FOR CONTROLLING THE SAME

(71) Applicant: HYUNDAI MOBIS CO., LTD., Seoul (KR)

(72) Inventor: Jung Young LEE, Yongin-si (KR)

(73) Assignee: HYUNDAI MOBIS CO., LTD., Seoul (KR)

(21) Appl. No.: 18/062,548

(22) Filed: Dec. 6, 2022

(30) Foreign Application Priority Data
May 10, 2022 (KR) 10-2022-0056999

(51) Int. Cl. B60K 35/00; G06F 3/01

(52) U.S. Cl. CPC B60K 35/00; G06F 3/017; B60K 2370/1468; B60K 2370/21

(57) ABSTRACT

A system for recognizing a gesture of a vehicle and a method for controlling the same. The system includes gesture recognition means having a sensor for recognizing a gesture of a driver, manipulation means having a plurality of input means for recognizing a touch of the driver, a controller that receives a signal from the gesture recognition means and the manipulation means, and display means for displaying a screen by receiving the signal from the controller.

Pursuant to 35 U.S.C. § 119(a), this application claims the benefit of Korean Patent Application No. 10-2022-0056999, filed on May 10, 2022, which is hereby incorporated by reference as if fully set forth herein.

### BACKGROUND

### Field

Embodiments of the present disclosure relate to a vehicle gesture recognition system applicable to vehicles in all fields and a method for controlling the same, and relates to a system that recognizes a driver's motion as a gesture signal and performs a specific function of the vehicle corresponding to the signal.

### Discussion of the Related Art

In general, a physical screen touch or manipulation of a control panel, a gesture motion recognition function, and the like may be implemented for manipulating infotainment of a vehicle. In a case of gesture motion recognition, a gesture of a driver may be directly recognized with a camera or a motion of the driver performed at a specific location in the room may be recognized using a sensor or the like.

In such a gesture recognition system, a recognition success rate for accurately recognizing a gesture input of a user and a responsiveness for quickly processing the gesture recognition in an acquired image are considered to be very important factors.

A conventional gesture recognition system recognizes the gesture motion via a motion of a hand located at the specific location. However, a recognition accuracy thereof is not high, and there is an inconvenience that the hand has to be moved to the specific location. When a separate touch pad or dial device is added to improve gesture recognition accuracy and ease of manipulation, a cost increases, which is not desirable. There is a need to develop a technology for reducing inefficiency related to the conventional gesture recognition system.

In one example, in relation to the conventional gesture recognition system, reference may be made to U.S. Pat. No. 1,650,769 (“Voice recognition system for vehicle using gesture recognition”).

### SUMMARY

Embodiments of the present disclosure are to provide a gesture recognition system with a simple operation scheme.

Embodiments of the present disclosure are to provide a gesture recognition system that may reduce costs.

Embodiments of the present disclosure are to provide a gesture recognition system with excellent operation reliability.

The problems to be solved in the present disclosure are not limited to the technical problems mentioned above, and other technical problems that are not mentioned will be clearly understood by those with ordinary knowledge in the technical field to which the present disclosure belongs from the description below.

A system for recognizing a gesture equipped in a vehicle according to one of the embodiments of the present disclosure includes gesture recognition means having a sensor for recognizing a gesture of a driver, manipulation means having a plurality of input means for recognizing a touch of the driver, a controller that receives a signal from the gesture recognition means and the manipulation means, and display means for displaying a screen by receiving the signal from the controller.

Preferably, the sensor of the gesture recognition means is a camera sensor.

In addition, preferably, the manipulation means includes at least two input means arranged in a line, and, when the at least two input means arranged in the line are touched in sequence, the controller recognizes the touch of the at least two input means as a gesture signal.

In addition, preferably, when the at least two input means arranged in the line are touched in sequence within a first time duration, the controller recognizes the touch of the at least two input means as a directional gesture signal, and the first time duration is 500 milliseconds (ms).

In addition, preferably, the manipulation means includes at least three input means arranged in a line, and, when the at least three input means arranged in the line are touched in sequence within the first time duration, the controller recognizes the touch of the at least three input means as the directional gesture signal.

In addition, preferably, the at least three input means arranged in the line are first input means, second input means, and third input means arranged in order, when the at least three input means arranged in the line are touched in a first order within a second time duration, the controller recognizes the touch of the at least three input means as a functional gesture signal, the second time duration is 1000 milliseconds (ms), and the first order is an order of the first input means, the second input means, the third input means, the second input means, and the first input means.

In addition, preferably, the first input means, the second input means, and the third input means are arranged in a horizontal direction in the manipulation means.

In addition, preferably, the first input means, the second input means, and the third input means are arranged in a vertical direction.

In addition, preferably, the manipulation means further includes fourth input means and fifth input means, and the fourth input means is disposed above the second input means, and the fifth input means is disposed below the second input means, so that the fourth input means, the second input means, and the fifth input means are arranged in a line in a vertical direction.

In addition, preferably, the functional gesture signal includes a signal for executing or cancelling a specific function, and the directional gesture signal includes signals of a leftward direction, a rightward direction, an upward direction, and a downward direction.

In addition, preferably, the plurality of input means of the manipulation means recognize the touch of the driver in a capacitive touch scheme, a pressure-sensitive touch scheme, and a button scheme.

A system for recognizing a gesture equipped in a vehicle includes manipulation means having a plurality of input means for recognizing a touch of a driver, a controller that receives a signal from the manipulation means, and display means for displaying a screen by receiving the signal from the controller.

Preferably, the manipulation means includes at least three input means arranged in a line. When the at least three input means arranged in the line are touched in sequence within a first time duration, the controller recognizes the touch of the at least three input means as a directional gesture signal, the first time duration is 500 milliseconds (ms), and the directional gesture signal includes signals of a leftward direction, a rightward direction, an upward direction, and a downward direction.

A method for controlling the gesture recognition system includes (a) transmitting, by manipulation means, touch signals of a driver to a controller, (b) identifying, by the controller, whether the touch signals of the driver are successively input, (c) identifying, by the controller, whether the successive touch signals of the driver are different signals, and (d) identifying, by the controller, whether the touch signals of the driver are input within a specific time duration.

In a vehicle equipped with the gesture recognition system, manipulation means of the gesture recognition system includes at least three input means arranged in a line, and, when the at least three input means arranged in the line are touched in sequence within a specific time duration, a controller of the gesture recognition system recognizes the touch of the at least three input means as a directional gesture signal.

According to one of the embodiments of the present disclosure, the gesture recognition may be performed with pressing of the touch-type or physical button-type steering wheel or manipulation system button.

In addition, according to one of the embodiments of the present disclosure, as a scheme different from an existing infotainment manipulation scheme is provided, a variety of infotainment manipulation methods may be provided.

In addition, according to one of the embodiments of the present disclosure, the accuracy of the gesture recognition may be supplemented with a simple scheme.

In addition, according to one of the embodiments of the present disclosure, because a high-cost configuration for the gesture recognition accuracy is not required, a cost of implementing the gesture recognition may be reduced.

Effects that may be obtained from the present disclosure are not limited to the effects mentioned above, and other effects not mentioned will be clearly understood by those of ordinary skill in the technical field to which the present disclosure belongs from the description below.

### BRIEF DESCRIPTION OF THE DRAWINGS

FIG. 1 is an example of an entire block diagram of a vehicle system according to one of embodiments of the present disclosure.

FIG. 2 shows an example of a vehicle to which a gesture recognition system according to one of embodiments of the present disclosure is applicable.

FIG. 3 is a flowchart of an operation scheme of a gesture recognition system according to one of embodiments of the present disclosure.

FIG. 4 illustrates an operation method of gesture recognition means of a gesture recognition system according to one of embodiments of the present disclosure.

FIG. 5 shows manipulation means of a gesture recognition system according to one of embodiments of the present disclosure.

FIG. 6 illustrates an operation method of manipulation means of a gesture recognition system according to one of embodiments of the present disclosure.

FIG. 7 shows manipulation means of a gesture recognition system according to one of embodiments of the present disclosure.

FIG. 8 illustrates an operation method of manipulation means of a gesture recognition system according to one of embodiments of the present disclosure.

FIG. 9 is a flowchart of an operation method of a gesture recognition system according to one of embodiments of the present disclosure.

### DESCRIPTION OF SPECIFIC EMBODIMENTS

Hereinafter, an embodiment of the present disclosure will be described in detail with reference to the accompanying drawings such that a person with ordinary skill in the technical field to which the present disclosure belongs may easily implement the embodiment. However, the present disclosure may be implemented in several different forms and may not be limited to the embodiment described herein. In addition, in order to clearly illustrate the present disclosure in the drawings, components irrelevant to the description are omitted, and like reference numerals are assigned to like components throughout the specification.

Throughout the specification, when a portion “includes” a certain component, this means that other components may be further included without being excluded unless otherwise stated.

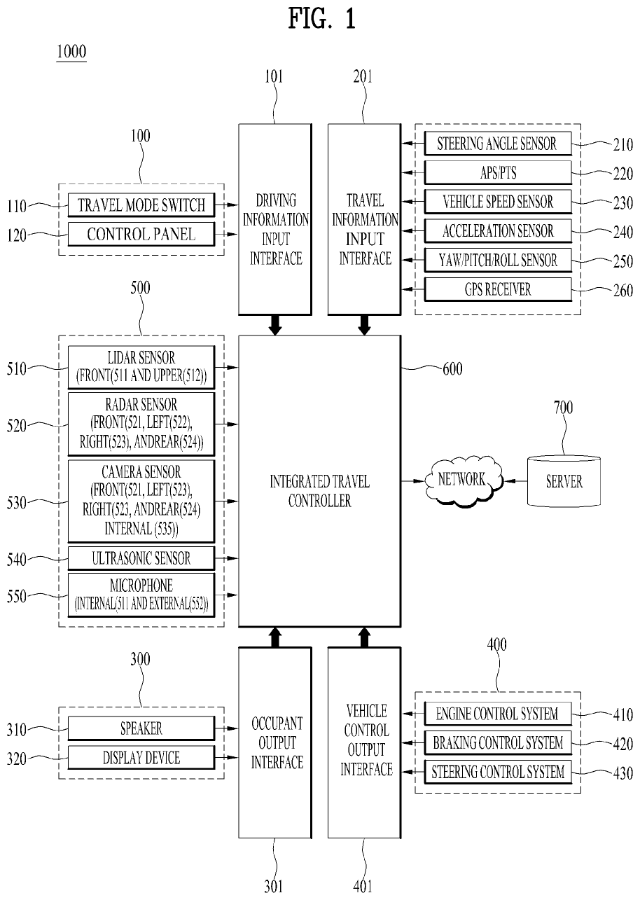

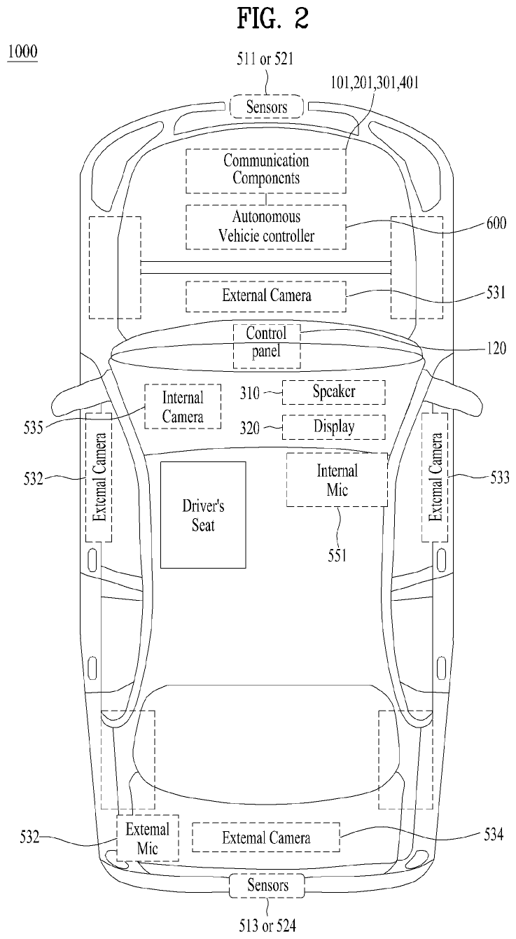

FIG. 1 is an example of an entire block diagram of a vehicle system according to one of embodiments of the present disclosure. FIG. 2 shows an example of a vehicle to which a system according to one of embodiments of the present disclosure is applicable.

First, a structure and a function of a vehicle to which a system according to the present embodiments may be applied will be described with reference to FIGS. 1 and 2.

As shown in FIG. 1, a vehicle 1000 may be implemented centering on an integrated travel controller 600 that transmits and receives data required for controlling travel of the vehicle via a driving information input interface 101, a travel information input interface 201, an occupant output interface 301, and a vehicle control output interface 401. However, the integrated travel controller 600 may be referred to as a controller, a processor, or simply a control unit in this specification.

The integrated travel controller 600 may acquire driving information based on manipulation on user input means 100 by an occupant in an autonomous driving mode or a manual driving mode of the vehicle via the driving information input interface 101. As shown in FIG. 1, the user input means 100 may include a travel mode switch 110 and a control panel 120 (e.g., a navigation terminal mounted on the vehicle, a smartphone or a tablet PC possessed by the occupant, and the like). Accordingly, the driving information may include travel mode information and navigation information of the vehicle.

For example, a travel mode (that is, an autonomous driving mode/a manual driving mode or a sports mode/an eco mode/a safe mode/a normal mode) of the vehicle determined by manipulation on the travel mode switch 110 by the occupant may be transmitted to the integrated travel controller 600 via the driving information input interface 101 as the above-described driving information.

In addition, the navigation information such as a destination of the occupant input via the control panel 120 by the occupant and a route to the destination (the shortest route, a preferred route, or the like selected by the occupant among candidate routes to the destination) may be transmitted to the integrated travel controller 600 via the driving information input interface 101 as the above-described driving information.

In one example, the control panel 120 may be implemented as a touch screen panel that provides a user interface (UI) for a driver to input or modify information for controlling autonomous driving of the vehicle. In this case, the aforementioned travel mode switch 110 may be implemented as a touch button on the control panel 120.

In addition, the integrated travel controller 600 may acquire travel information indicating a travel state of the vehicle via the travel information input interface 201. The travel information may include various information indicating a steering angle formed as the occupant manipulates a steering wheel, an accelerator pedal stroke or a brake pedal stroke formed as an accelerator pedal or a brake pedal is pressed, and the travel state and a behavior of the vehicle, such as a vehicle speed, an acceleration, a yaw, a pitch, and a roll as the behavior occurred in the vehicle. As shown in FIG. 1, each of the travel information may be detected by travel information detecting means 200 including a steering angle sensor 210, an accel position sensor (APS)/a pedal travel sensor (PTS) 220, a vehicle speed sensor 230, an acceleration sensor 240, and a yaw/pitch/roll sensor 250.

Furthermore, the travel information of the vehicle may include location information of the vehicle, and the location information of the vehicle may be acquired via a global positioning system (GPS) receiver 260 applied to the vehicle. Such travel information may be transmitted to the integrated travel controller 600 via the travel information input interface 201 and may be utilized to control the travel of the vehicle in the autonomous driving mode or the manual driving mode of the vehicle.

In addition, the integrated travel controller 600 may transmit travel state information provided to the occupant in the autonomous driving mode or the manual driving mode of the vehicle to output means 300 via the occupant output interface 301. That is, as the integrated travel controller 600 transmits the travel state information of the vehicle to the output unit 300, the occupant may identify an autonomous travel state or a manual travel state of the vehicle based on the travel state information output via the output means 300. The travel state information may include, for example, various information indicating the travel state of the vehicle, such as a a current travel mode of the vehicle, a shift range, and a vehicle speed.

In addition, when it is determined that a warning is necessary to the driver in the autonomous driving mode or the manual driving mode of the vehicle together with the travel state information described above, the integrated travel controller 600 may transmit warning information to the output means 300 via the occupant output interface 301, so that the output means 300 may output the warning to the driver. In order to output such travel state information and warning information audibly and visually, the output means 300 may include a speaker 310 and a display device 320 as shown in FIG. 1. In this regard, the display device 320 may be implemented as the same device as the aforementioned control panel 120 or as a separate and independent device.

In addition, the integrated travel controller 600 may transmit control information for controlling the travel of the vehicle in the autonomous driving mode or the manual driving mode of the vehicle to a subordinate control system 400 applied to the vehicle via the vehicle control output interface 401. The subordinate control system 400 for controlling the travel of the vehicle may include an engine control system 410, a braking control system 420, and a steering control system 430 as shown in FIG. 1. The integrated travel controller 600 may transmit engine control information, braking control information, and steering control information as the control information to the respective subordinate control systems 410, 420, and 430 via the vehicle control output interface 401. Accordingly, the engine control system 410 may control the vehicle speed and the acceleration of the vehicle by increasing or decreasing an amount of fuel supplied to an engine, the braking control system 420 may control the braking of the vehicle by adjusting a braking force of the vehicle, and the steering control system 430 may control steering of the vehicle via a steering device (e.g., a motor driven power steering (MDPS) system) applied to the vehicle.

As described above, the integrated travel controller 600 of the present embodiment may acquire the driving information based on the manipulation of the driver and the travel information indicating the travel state of the vehicle via the driving information input interface 101 and the travel information input interface 201, respectively, transmit the travel state information and the warning information generated based on an autonomous driving algorithm to the output means 300 via the occupant output interface 301, and transmit the control information generated based on a travel algorithm to the subordinate control system 400 via the vehicle control output interface 401 such that the travel of the vehicle is controlled.

In order to ensure stable autonomous travel of the vehicle, it is necessary to continuously monitor the travel state by accurately measuring a travel environment of the vehicle and to control the travel based on the measured travel environment. To this end, the vehicle according to the present embodiment may include sensor means 500 for detecting objects surrounding the vehicle, such as a surrounding vehicle, a pedestrian, a road, or a fixed facility (e.g., a traffic light, a milestone, a traffic sign, a construction fence, and the like) as shown in FIG. 1.

As shown in FIG. 1, the sensor means 500 may include at least one of a lidar sensor 510, a radar sensor 520, and a camera sensor 530 to detect the surrounding objects outside the vehicle.

The lidar sensor 510 may detect the surrounding object outside the vehicle by transmitting a laser signal to a vicinity of the vehicle and receiving the signal that is reflected from the corresponding object and returned, and may detect the surrounding object located within a set distance and set ranges of a vertical field of view and a horizontal field of view predefined based on a specification thereof. The lidar sensor 510 may include a front lidar sensor 511, an upper lidar sensor 512, and a rear lidar sensor 513 installed on a front surface, a top surface, and a rear surface of the vehicle, respectively, but installation locations and the numbers thereof are not limited to those in a specific embodiment. A threshold value for determining validity of the laser signal reflected back from the corresponding object may be stored in advance in a memory (not shown) of the integrated travel controller 600, and the integrated travel controller 600 may determine a location (including a distance to the corresponding object), a speed, and a direction of movement of the corresponding object in a scheme of measuring a time for the laser signal transmitted via the lidar sensor 510 to be reflected back from the corresponding object.

The radar sensor 520 may detect the surrounding object outside the vehicle by emitting an electromagnetic wave to the vicinity of the vehicle and receiving the signal that is reflected from the corresponding object and returned, and may detect the surrounding object located within a set distance and set ranges of a vertical field of view and a horizontal field of view predefined based on a specification thereof. The radar sensor 520 may include a front radar sensor 521, a left radar sensor 521, a right radar sensor 522, and a rear radar sensor 523 installed on a front surface, a left side surface, a right side surface, and a rear surface of the vehicle, respectively, but installation locations and the numbers thereof are not limited to those in a specific embodiment. The integrated travel controller 600 may determine the location (including the distance to the corresponding object), the speed, and the direction of movement of the corresponding object in a scheme of analyzing power of the electromagnetic wave transmitted and received via the radar sensor 520.

The camera sensor 530 may detect the surrounding object outside the vehicle by photographing the surroundings of the vehicle, and may detect the surrounding object located within a set distance and set ranges of a vertical field of view and a horizontal field of view predefined based on a specification thereof. The vertical field of view and the horizontal field of view of the camera sensor 530 may be adjustable. That is, by adjusting the range of the field of view, a range in which the object (e.g., the surrounding vehicle) is detected may be appropriately manipulated as needed.

The camera sensor 530 may include a front camera sensor 531, a left camera sensor 532, a right camera sensor 533, and a rear camera sensor 534 respectively installed on the front surface, the left side surface, the right side surface, and the rear surface of the vehicle, but installation locations and the numbers thereof are not limited to those in a specific embodiment. The integrated travel controller may determine the location (including the distance to the corresponding object), the speed, the direction of movement, and the like of the corresponding object by applying predefined image processing to an image captured via the camera sensor 530.

In addition, an internal camera sensor 535 for imaging the inside of the vehicle may be mounted at a predetermined location (e.g., on a rearview mirror) inside the vehicle, and the integrated travel controller 600 may monitor a behavior and a state of the occupant based on the image acquired via the internal camera sensor 535 and output a guide or a warning to the occupant via the above-described output means 300.

In addition to the lidar sensor 510, the radar sensor 520, and the camera sensor 530, the sensor means 500 may further include an ultrasonic sensor 540 as shown in FIG. 1. In addition, various types of sensors for detecting the surrounding object of the vehicle may be further employed in the sensor means 500.

Although FIG. 2 show an example in which the front lidar sensor 511 or the front radar sensor 521 is installed on the front surface of the vehicle, the rear lidar sensor 513 or the rear radar sensor 524 is installed on the rear surface of the vehicle, and the front camera sensor 531, the left camera sensor 532, the right camera sensor 533, and the rear camera sensor 534 are installed on the front surface, the left side surface, the right side surface, and the rear surface of the vehicle, respectively, to help understand the present embodiment, as described above, the installation location and the number of each sensor are not limited to those in the specific embodiment.

Furthermore, the sensor means 500 may further include a biometric sensor for detecting biosignals (e.g., a heart rate, an electrocardiogram, a respiration, a blood pressure, a body temperature, a brain wave, a blood flow (a pulse wave), a blood sugar, and the like) of the occupant in order to determine the state of the occupant in the vehicle. The biosensor may include a heart rate sensor, an electrocardiogram sensor, a respiration sensor, a blood pressure sensor, a body temperature sensor, an electroencephalogram sensor, a photoplethysmography sensor, a blood sugar sensor, and the like.

Finally, the sensor means 500 additionally includes a microphone 550, and an internal microphone 551 and an external microphone 552 are used for different purposes.

The internal microphone 551 may be used, for example, to analyze a voice of the occupant boarded the autonomous vehicle 1000 based on AI or the like, or to respond immediately to a direct voice command.

On the other hand, the external microphone 552 may be used, for example, to appropriately respond for safe driving by analyzing various sounds generated outside of the autonomous vehicle 1000 using various analysis tools such as deep learning.

For reference, components shown in FIG. 2 are able to perform the same or similar functions as those shown in FIG. 1, and FIG. 2 more specifically (based on the inside of the vehicle 1000) illustrates a relative location relationship of the components compared to FIG. 1.

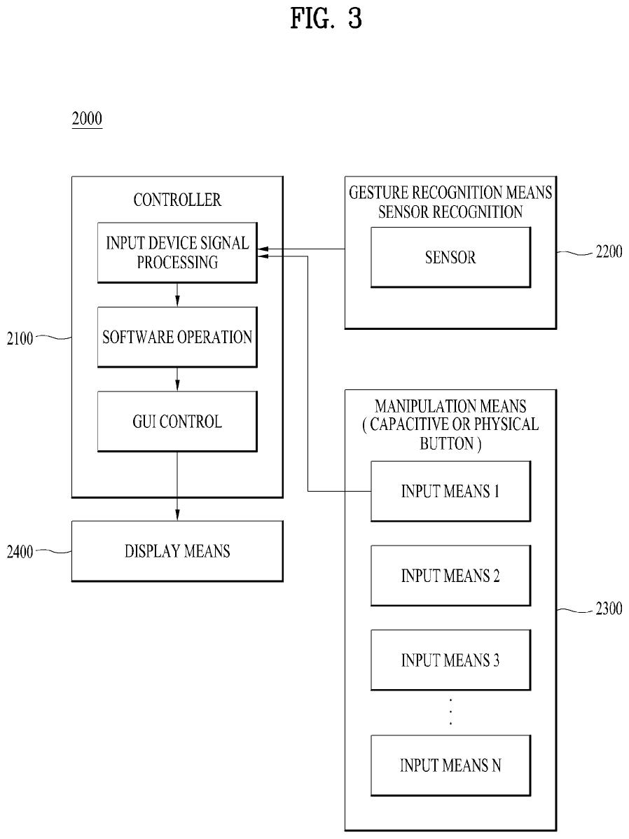

FIG. 3 is a flowchart of an operation scheme of a gesture recognition system (hereinafter, referred to as a “gesture recognition system”) 2000 according to one of the embodiments of the present disclosure.

The gesture recognition system 2000 may include a controller 2100, gesture recognition means 2200, manipulation means 2300, and display means 2400.

The controller 2100 is a component that receives a signal from the gesture recognition means 2200 or the manipulation means 2300, processes the signal, and transmits the signal to the display means.

The controller 2100 may correspond to the integrated travel controller 600 in FIG. 1. The controller 2100 may acquire and process a sensor signal generated by a user's gesture or a signal generated by a button input or a touch input of the user.

The controller 2100 may process the acquired signal to perform a software operation corresponding thereto, and control a graphical user interface (GUI) to output the signal on the display means 2400.

The controller 2100 may recognize a button signal or a gesture signal in response to the signal received from the manipulation means 2300, and perform data processing accordingly. The gesture signal may include a directional gesture signal and a functional gesture signal. The directional gesture signal may be a gesture signal indicating a direction such as a leftward direction, a rightward direction, an upward direction, a downward direction, and the like, and the functional gesture signal may be a gesture signal indicating execution of a function such as execution or cancellation and zoom in or zoom out.

The display means 2400 according to embodiments may correspond to a display 320 in FIG. 1. The display means 2400 is a component that receives a signal from the controller 2100 and displays the screen. The display means 2400 may include various components (an LED, an OLED, an LCD, a HUD, and the like) capable of displaying the screen.

The gesture recognition means 2200 according to embodiments is a component that recognizes the motion (the gesture) of the user (or the driver) and transmits a signal corresponding to the specific motion to the controller 2100. The gesture recognition means 2200 includes an IR sensor, a camera sensor, or the like capable of recognizing the gesture of the user. In this regard, the camera sensor may correspond to the internal camera sensor 535 for imaging the inside of the vehicle in FIG. 1. The sensor of the gesture recognition means 2200 may recognize the behavior or the various states of the occupant, and transmit a corresponding signal to the controller 2100, and the controller 2100 may control the screen output on the display means 2400 accordingly. The sensor of the gesture recognition means 2200 may not be limited to the camera sensor, and other known types of sensors may be applied by a person of ordinary skill in the art (hereinafter, referred to as “a person skilled in the art”).

The gesture recognition means 2200 may configure various motion inputs, such as a movement in the upward/downward/leftward/rightward direction, the zoom in, the zoom out, the motion cancellation, and the like. The data input from the sensor of the gesture recognition means 2200 may be calculated, converted into data about the motion, and then transmitted to the controller 2100.

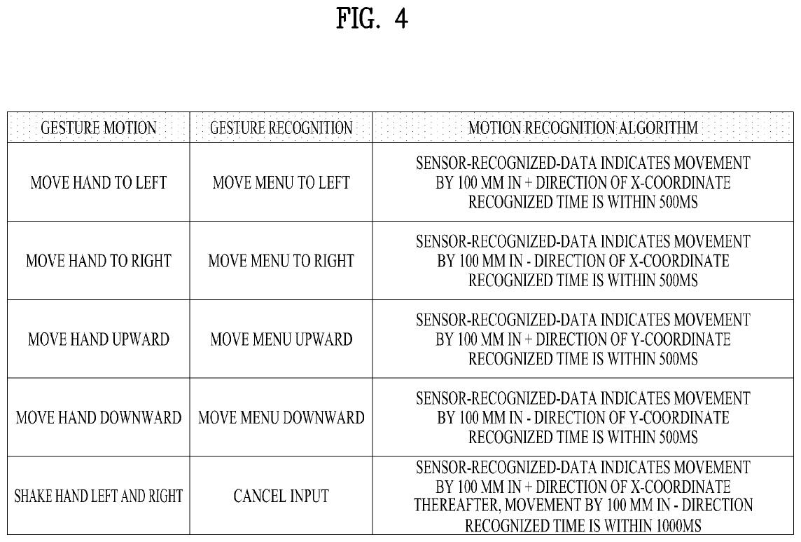

FIG. 4 illustrates an embodiment of an operation method of the gesture recognition means 2200.

Referring to a table shown in FIG. 4, the motions of the user that may be recognized by the gesture recognition means 2200 include moving a hand to the left, moving the hand to the right, moving the hand up, moving the hand down, shaking the hand left and right, and the like, but types of the motion (the gesture) of the user are not limited to the contents described herein.

Each of the user motions may be recognized by the sensor of the gesture recognition means 2200, and may correspond to each of menu leftward movement, menu rightward movement, menu upward movement, menu downward movement, and cancel or execution functions by the gesture recognition.

An algorithm for the sensor of the gesture recognition means 2200 to recognize each motion of the user may be as follows.

When the data recognized by the sensor indicates a movement in a + direction (or may be in a − direction) of an X-coordinate by a specific distance (e.g., 100 mm) or more, and a recognized time duration is within a specific time duration (e.g., 500 ms), the gesture recognition means 2200 may recognize that the user has moved the hand to the left and transmit a signal, and the controller 2100 may move the menu on the screen displayed on the display means 2400 to the left by recognizing the gesture signal.

When the data recognized by the sensor indicates a movement in the − direction (or may be in the + direction) of the X-coordinate by 100 m or more, and the recognized time duration is within 500 ms, the gesture recognition means 2200 may recognize that the user has moved the hand to the right and transmit a signal, and the controller 2100 may move the menu on the screen displayed on the display means 2400 to the right by recognizing the gesture signal.

When the data recognized by the sensor indicates a movement in a + direction (or may be in a − direction) of a Y-coordinate by 100 m or more, and the recognized time duration is within 500 ms, the gesture recognition means 2200 may recognize that the user has moved the hand upward and transmit a signal, and the controller 2100 may move the menu on the screen displayed on the display means 2400 upward by recognizing the gesture signal.

When the data recognized by the sensor indicates a movement in the − direction (or may be in the + direction) of the Y-coordinate by 100 m or more, and the recognized time duration is within 500 ms, the gesture recognition means 2200 may recognize that the user has moved the hand downward and transmit a signal, and the controller 2100 may move the menu on the screen displayed on the display means 2400 downward by recognizing the gesture signal.

When the data recognized by the sensor indicates the movement in the + direction of the X-coordinate by 100 m or more and the movement in the − direction by 100 m or more, and the recognized time duration is within 100 ms, the gesture recognition means 2200 may recognize that the user has shaken the hand left and right and transmit a signal, and the controller 2100 may perform the cancelation or execution operation of the screen displayed on the display means 2400 by recognizing the gesture signal.

In the gesture recognition means 2200, a reference movement distance (100 mm) or a reference time duration (500 ms and 1000 ms) of an algorithm for recognizing the gesture motion of the user may be appropriately changed by a person skilled in the art. In addition, various functions corresponding to the gesture motions of the user may not be limited to those described herein, and other functions may be performed in association with gesture motions of the user. For example, map zoom in or zoom out and map movement functions may be performed in association with a gesture motion of the user.

The manipulation means 2300 according to the embodiments includes a plurality of input means for recognizing the touch of the user. The input means may include a touch panel that recognizes the user's input in a capacitive touch scheme or a pressure-sensitive touch scheme. In addition, the input means may be formed as a button or a switch to recognize a physical pressing motion of the user. The manipulation means 2300 may correspond to the user input means 100 in FIG. 1.

The manipulation means 2300 may be composed of touch-type or physical switch-type means and may control an infotainment system. The manipulation means 2300 may include various input means (manipulation buttons) such as a steering wheel or a central air conditioning manipulation system. The input means may include manipulation buttons matched with various functions such as volume adjustment, frequency adjustment, input, cancellation, air conditioning operation, and power buttons. Touch sensors of the respective input means may be separated from each other or the input means may be separated from each other. That is, the input means may be touch or physical buttons independent of each other.

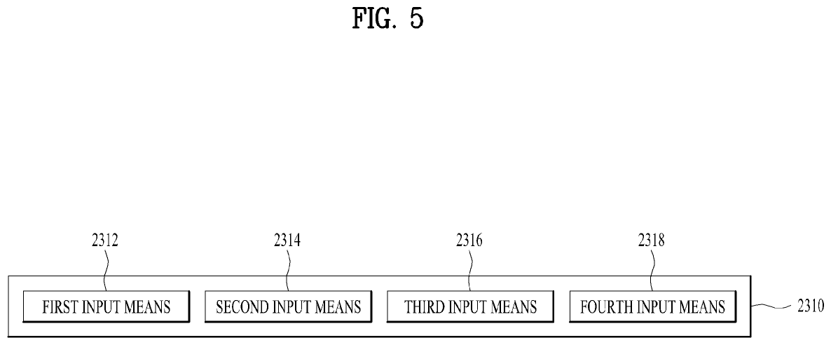

FIG. 5 shows manipulation means 2310 of a first embodiment of the present disclosure. The manipulation means 2310 may include a plurality of input means 2312, 2314, 2316, and 2318. As shown in FIG. 5, the plurality of input means may be arranged in a line. The input means may be referred to as first input means 2312, second input means 2314, third input means 2316, and fourth input means 2318, respectively.

When the touch input is made to each input means, a signal for performing a specific function (radio, navigation, media, setup, and the like) of the vehicle corresponding to each input means may be transmitted to the controller 2100.

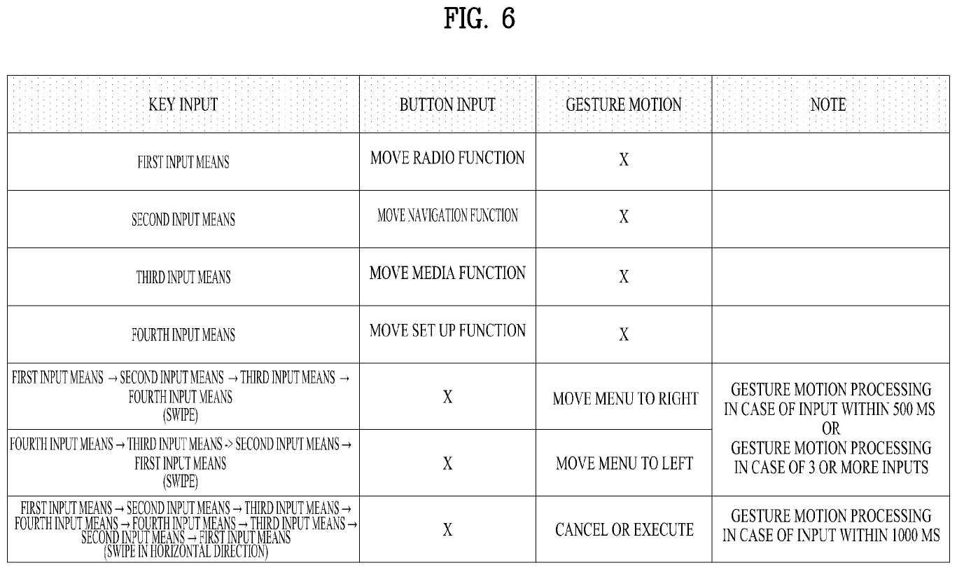

FIG. 6 illustrates an operation method of the manipulation means 2310 of the first embodiment of the present disclosure.

Referring to FIG. 6, when the first input means 2312 is touched by the user, the controller 2100 may control the display means 2400 to display a radio function screen. When the second input means 2314 is touched by the user, the controller 2100 may control the display means 2400 to display a navigation function screen. When the third input means 2316 is touched by the user, the controller 2100 may control the display means 2400 to display a media function screen. When the fourth input means 2318 is touched by the user, the controller 2100 may control the display means 2400 to display a setup function screen.

In addition, when the first input means 2312, the second input means 2314, the third input means 2316, and the fourth input means 2318 are touched by the user in sequence or successively, the controller 2100 may recognize the gesture signal and move the menu of the screen of the display means 2400 to the right in response to the corresponding gesture signal.

In addition, when the fourth input means 2318, the third input means 2316, the second input means 2314, and the first input means 2312 are touched by the user in sequence or successively, the controller 2100 may recognize the gesture signal and move the menu of the screen of the display means 2400 to the left in response to the corresponding gesture signal.

In addition, when the input means are touched by the user in an order of the first input means 2312->the second input means 2314->the third input means 2316->the fourth input means 2318->the third input means 2316->the second input means 2314->the first input means 2312, the controller 2100 may recognize the gesture signal and perform a menu cancellation operation of the screen of the display means 2400 in response to the corresponding gesture signal.

A motion input as the plurality of input means are touched in sequence may be recognized as the gesture motion when performed within a specific time duration. For example, when the input means are pressed (or touched) within a first time duration (e.g., 500 milliseconds) in an order of the first input means 2312->the second input means 2314->the third input means 2316, this may be recognized as the gesture motion and the controller 2100 may perform a corresponding function.

In addition, when the input means are pressed by the user in an order of the first input means 2312->the second input means 2314->the third input means 2316->the fourth input means 2318->the third input means 2316->the second input means 2314->the first input means 2312, this may be recognized as the gesture motion on condition that the input means are pressed within a second time duration (e.g., 1000 milliseconds).

In one example, when the input means are pressed by the user successively in an order of the first input means 2312->the third input means 2316, the controller 2100 may recognize the gesture signal and move the menu of the screen of the display means 2400 to the right in response to the corresponding gesture signal. That is, even when the second input means 2314 located in the middle is not touched, the gesture signal may be recognized by the controller 2100.

In the manipulation means 2300, at least two of the plurality of input means may be arranged in a line. In addition, in the manipulation means 2300, some of the plurality of input means may be arranged in a line. When some of the plurality of input means arranged in a line are pressed in a specific order or within a time duration, the controller 2100 may recognize this as the gesture signal and perform a corresponding function.

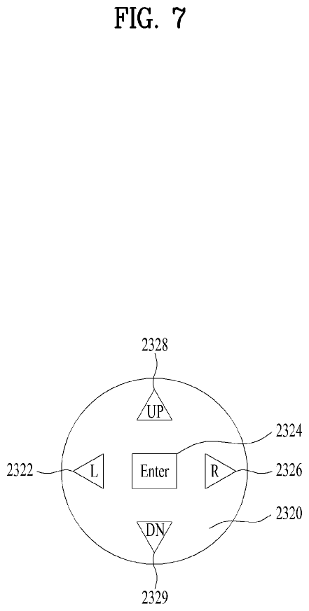

FIG. 7 shows manipulation means 2320 according to a second embodiment of the present disclosure. The manipulation means 2320 according to the second embodiment represents a form in which a plurality of input means are arranged so as to indicate left and right directions and up and down directions.

In the second embodiment, first input means 2322 is disposed on a left side, second input means 2324 is disposed on a central portion, and third input means 2326 is disposed on a right side. Fourth input means 2328 may be disposed above the second input means 2324, and fifth input means 2329 may be disposed below the second input means 2324. That is, an arrangement of the plurality of input means may represent a ‘+’ shape.

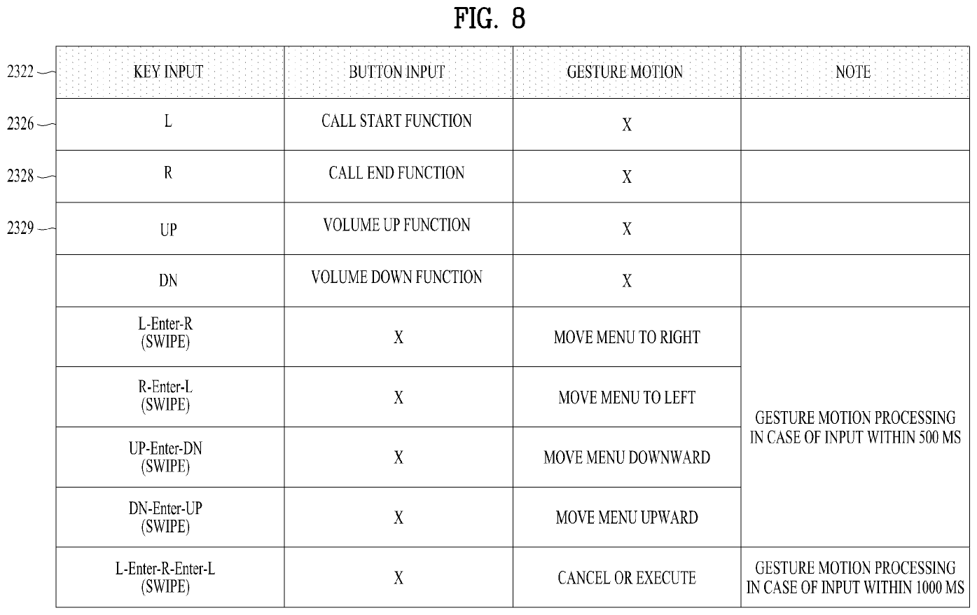

FIG. 8 illustrates an operation method of the manipulation means 2320 according to the second embodiment.

Referring to FIG. 8, when each of the first input means 2322, the third input means 2326, the fourth input means 2328, and the fifth input means 2329 is pressed independently, the each of the input means may be matched with each of functions such as call start, call end, volume up, volume down, and the like. The second input means 2324 may be matched with the execution function. That is, each input means may be matched with a function to be executed when touched (pressed) alone.

When the input means 2322, 2324, and 2326 among the plurality of input means are pressed within a first time duration (e.g., 500 ms) successively in an order of the first input means 2322->the second input means 2324->the third input means 2326, the controller 2100 may recognize the directional gesture signal (the rightward direction) and move the menu screen to the right on the display means 2400.

In addition, when the input means 2322, 2324, and 2326 among the plurality of input means are pressed within the first time duration (e.g., 500 ms) successively in an order of the third input means 2326->the second input means 2324->the first input means 2322, the controller 2100 may recognize the directional gesture signal (the leftward direction) and move the menu screen to the left on the display means 2400.

When the input means 2324, 2328, and 2329 among the plurality of input means are pressed within the first time duration (e.g., 500 ms) successively in an order of the fourth input means 2328->the second input means 2324->the fifth input means 2329, the controller 2100 may recognize the directional gesture signal (the downward direction) and move the menu screen downward on the display means 2400.

When the input means 2324, 2328, and 2329 among the plurality of input means are pressed within the first time duration (e.g., 500 ms) successively in an order of the fifth input means 2329->the second input means 2324->the fourth input means 2328, the controller 2100 may recognize the directional gesture signal (the upward direction) and move the menu screen upward on the display means 2400.

When the input means 2322, 2324, and 2326 among the plurality of input means are pressed within the second time duration (e.g., 1000 ms) successively in an order of the first input means 2322->the second input means 2324->the third input means 2326->the second input means 2324->the first input means 2322, the controller 2100 may recognize the functional gesture signal (the cancellation or the execution), and execute or cancel the menu screen on the display means 2400.

The order in which the plurality of input means are pressed (the first order, the second order, and the like), the reference time duration during which the pressing is made (the first time duration, the second time duration, and the like), the function in response to the corresponding gesture signal, and the like may be variously changed by those skilled in the art within the scope of the technical idea of the present disclosure.

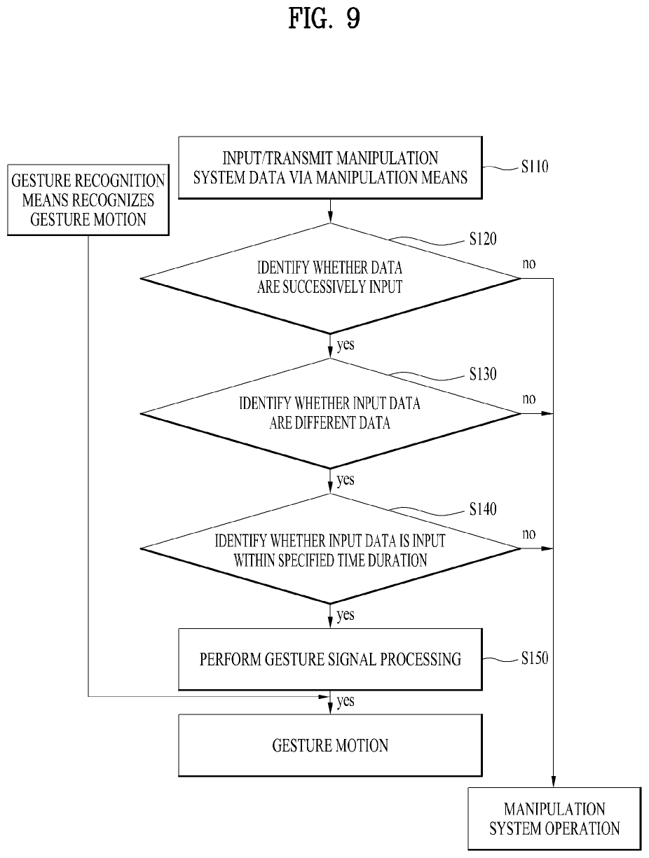

FIG. 9 is a flowchart illustrating a method for controlling the gesture recognition system 2000.

Referring to FIG. 9, the manipulation means 2300 according to the embodiments receives the user's input and transmits the signal thereof to the controller 2100 (S110).

The controller 2100 identifies whether the received signal is successively input (a first condition) (S120). When the data (of the signal) is not successively input, the controller 2100 may perform the operation of the manipulation system (the radio, the navigation, the media, the setup, and the like) based on the user input.

In a case of the successively input data, the controller 2100 identifies whether the input data are different data (a second condition) (S130). When the successively input data are the same, the controller 2100 may perform the operation of the manipulation system (the radio, the navigation, the media, the setup, and the like) based on the user input.

When the successively input data are different from each other, whether the successively input data are input within a specific time duration (a third condition) is identified (S140). In this regard, the specific time duration may be 500 ms or 1000 ms, and an appropriate time duration may be changed by a person skilled in the art.

When the successively input data are not input within the specific time period, the controller 2100 may perform the operation of the manipulation system (the radio, the navigation, the media, the setup, and the like) based on the user input.

When the successively input data are input within the specific time period, the controller 2100 may recognize the user input as the gesture signal and perform a gesture motion (the movement in the upward/downward/leftward/rightward direction, the execution and the cancellation of the function, and the like) in response to the corresponding gesture signal.

In one example, the performing of the gesture motion by the controller 2100 may be achieved as the user gesture is recognized by the gesture recognition means 2200.

The order of the steps S120, S130, and S140 performed in relation to the method for controlling the gesture recognition system 2000 may be changed.

The gesture recognition system 2000 according to the embodiments of the present disclosure may be equipped in a control system of the vehicle.

The gesture recognition system 2000 according to the embodiments of the present disclosure does not need to have a high-cost sensor required to increase recognition accuracy of the gesture motion, and the gesture motion is able to be performed using the input means of the manipulation means 2300, so that the infotainment of the vehicle may be easily controlled.

Accuracy of the gesture recognition may be increased by reinforcing the recognition accuracy of the gesture motion by the sensor in the manipulation means 2300, and various commands may be executed with a simple configuration. In addition, the gesture motion may be performed with an inexpensive input means configuration.

As another aspect of the present disclosure, the operation of the proposal or the invention described above may also be provided as a code that may be implemented, embodied, or executed by a “computer” (a comprehensive concept including a system on chip (SoC) or a microprocessor), an application storing or containing the code, a computer-readable storage medium, a computer program product, or the like.

The detailed descriptions of the preferred embodiments of the present disclosure disclosed as described above have been provided to enable those skilled in the art to implement and practice the present disclosure. Although the description has been made with reference to the preferred embodiments of the present disclosure, those skilled in the art will understand that the present disclosure may be variously modified and changed without departing from the scope of the present disclosure. For example, those skilled in the art may use the components described in the above-described embodiments in a scheme of combining the components with each other.

Accordingly, the present disclosure is not intended to be limited to the embodiments illustrated herein, but is to be accorded the widest scope consistent with the principles and novel features disclosed herein.

What is claimed is:

1. A system for recognizing a gesture in a vehicle, the system comprising:
gesture recognition means having a sensor for recognizing a gesture of a driver;
manipulation means having a plurality of input means for recognizing a touch of the driver;
a controller configured to receive a signal from the gesture recognition means and the manipulation means; and
display means for displaying a screen based on a signal from the controller.

2. The system of claim 1, wherein the sensor of the gesture recognition means is a camera sensor.

3. The system of claim 2, wherein the manipulation means includes at least two input means arranged in a line, and
when the at least two input means are touched in sequence, the controller is configured to recognize the touch of the at least two input means as a gesture signal.

4. The system of claim 3, wherein, when the at least two input means are touched in sequence within a first time duration of 500 milliseconds (ms), the controller is configured to recognize the touch of the at least two input means as a directional gesture signal.

5. The system of claim 4, wherein the manipulation means includes at least three input means arranged in a line, and
when the at least three input means are touched in sequence within the first time duration, the controller is configured to recognize the touch of the at least three input means as the directional gesture signal.

6. The system of claim 5, wherein the at least three input means comprises first input means, second input means, and third input means arranged in order, and
when the at least three input means are touched in a first order within a second time duration of 1000 milliseconds (ms), the controller is configured to recognize the touch of the at least three input means as a functional gesture signal,
wherein the first order is an order of the first input means, the second input means, the third input means, the second input means, and the first input means.

7. The system of claim 6, wherein the first input means, the second input means, and the third input means are arranged in a horizontal direction in the manipulation means.

8. The system of claim 6, wherein the first input means, the second input means, and the third input means are arranged in a vertical direction.

9. The system of claim 7, wherein the manipulation means further includes fourth input means and fifth input means, and
the fourth input means is disposed above the second input means, and the fifth input means is disposed below the second input means, so that the fourth input means, the second input means, and the fifth input means are arranged in a line in a vertical direction.

10. The system of claim 9, wherein the functional gesture signal includes a signal for executing or cancelling a specific function, and
the directional gesture signal includes signals of a leftward direction, a rightward direction, an upward direction, and a downward direction.

11. The system of claim 10, wherein the plurality of input means of the manipulation means recognize the touch of the driver via one of a capacitive touch scheme, a pressure-sensitive touch scheme, and a button scheme.

12. A system for recognizing a gesture equipped in a vehicle, the system comprising:
manipulation means having a plurality of input means for recognizing a touch of a driver;
a controller configured to receive a signal from the manipulation means; and
display means for displaying a screen based on a signal received from the controller,
wherein the manipulation means includes at least three input means arranged in a line,
wherein, when the at least three input means are touched in sequence within a first time duration of 500 milliseconds (ms), the controller is configured to recognize the touch of the at least three input means as a directional gesture signal, and
wherein the directional gesture signal includes signals of a leftward direction, a rightward direction, an upward direction, and a downward direction.

13. A method of controlling the gesture recognition system of claim 5, the method comprising:
(a) transmitting, by manipulation means, touch signals of a driver to the controller;
(b) identifying, by the controller, whether the touch signals of the driver are successively input;
(c) identifying, by the controller, whether the successive touch signals of the driver are different signals; and
(d) identifying, by the controller, whether the touch signals of the driver are input within a specific time duration.

14. The method of claim 13, wherein the controller is configured to recognize the touch signals of the driver as a gesture signal when a first condition that the touch signals of the driver are successively input at step (b), a second condition that the successive touch signals of the driver correspond to the different touch signals at step (c), and a third condition that the successive touch signals of the driver are input within the specific time duration at step (d) are satisfied.
